(19) United States
(12) Patent Application Publication
(10) Pub. No.: US 2017/0148422 A1
(43) Pub. Date: May 25, 2017

(54) REFRESH CONTROL METHOD AND APPARATUS OF DISPLAY DEVICE

(71) Applicant: HUAWEI TECHNOLOGIES CO.,LTD., Shenzhen (CN)

(72) Inventors: Yongbing Huang, Beijing (CN); Mingyu Chen, Beijing (CN); Zehan Cui, Beijing (CN); Shihai Xiao, Hangzhou (CN)

(73) Assignee: HUAWEI TECHNOLOGIES CO.,LTD., Shenzhen (CN)

(21) Appl. No.: 15/426,356

(22) Filed: Feb. 7, 2017

Related U.S. Application Data
(63) Continuation of application No. PCT/CN2015/081077, filed on Jun. 9, 2015.

(30) Foreign Application Priority Data
Aug. 8, 2014 (CN) 201410390119.4
Dec. 22, 2014 (CN) 201410810699.8

(51) Int. Cl. G09G 5/395; G09G 5/00

(52) U.S. Cl. CPC G09G 5/395; G09G 5/001; G09G 2360/12; G09G 2360/18; G09G 2310/0286; G09G 2310/0289

(57) ABSTRACT

A refresh control method and apparatus of a display device are disclosed, where the method includes: (201) periodically generating, a first refresh signal, and outputting an image frame for display that is stored in a frame buffer to a display panel; and (202) generating, a second refresh signal when determining that the image frame for display that is stored in the frame buffer changes, and outputting the image frame for display that is stored in the frame buffer to the display panel. A generation frequency of the second refresh signal is far less than a frequency required to ensure timely display of an image frame. In addition, an operation of refreshing an image frame is triggered by using an event, which may ensure timely display of the image frame, and avoid an unnecessary refresh operation, so as to reduce system resource consumption and memory consumption.

### CROSS-REFERENCE TO RELATED APPLICATIONS

This application is a continuation of International Application No. PCT/CN2015/081077, filed on Jun. 9, 2015, which claims priority to Chinese Patent Application No. 201410810699.8, filed on Dec. 22, 2014, and Chinese Patent Application No. 201410390119.4, filed on Aug. 8, 2014. All of the aforementioned patent applications are hereby incorporated by reference in their entireties.

### TECHNICAL FIELD

The present invention relates to the field of computer technologies, and in particular, to a refresh control method and apparatus of a display device.

### BACKGROUND

A computer system generally includes a display device in a particular form, and a mobile device is used as an example. An LCD (Liquid Crystal Display, liquid crystal display) or OLED (Organic Light Emitting Diode, organic light emitting diode) display system is integrated in most smartphones. Such a display system mainly includes three parts: an application processor, a storage device (which includes a frame buffer), and a display device (which includes a display controller and a display panel). The application processor is responsible for drawing and generating an image frame, and storing the generated image frame in the frame buffer in the storage device. The frame buffer is used to store data of pixels on a display screen. The display controller is mainly responsible for reading the data of the pixels from the frame buffer, and sequentially writing the data of the pixels into logic circuits on the display panel that are corresponding to the pixels.

In a process of displaying an image by the display system, the application processor continuously generates a new image frame, and sends the image frame to the frame buffer. Therefore, the display controller needs to read the image frame from the frame buffer, and output the image frame to a display. This process is referred to as refresh of the image frame.

An LCD display device is used as an example, and mainly includes: an application processor, a frame buffer in a physical memory, an LCD controller, and an LCD panel. The frame buffer stores data of pixels on a screen, and a memory controller serves as a medium for interaction between the application processor and the LCD controller. An application or a service that runs in the application processor is responsible for drawing an image frame, and storing the drawn image frame to the frame buffer. When a frame refresh operation occurs, a DMA (Direct Memory Access, direct memory access) controller inside the LCD controller sequentially generates requests for accessing the frame buffer, and sends the requests to the memory controller. The memory controller reads data of pixels that is in the frame buffer inside a memory system, and returns the data to the DMA controller. After receiving the data returned by the memory controller, the DMA controller sends the data to the LCD panel for display.

A refresh controller of the LCD display device is responsible for generating an image frame refresh operation. The refresh controller regularly generates a refresh signal according to time sequence logic. A period for generating the refresh signal by the refresh controller is specified by an operating system or a user. A display device performs refresh for two main objectives: One is to keep a pixel on a screen from being distorted; the other is to display a modified image frame in a timely manner. Because a pixel distortion time period is relatively long, a relatively short refresh period can ensure that the pixel is not distorted. For different application programs, image update frequencies are different, and requirements on screen refresh frequencies are also different. For example, an update frequency of a text type application is around 10 Hz, and an update frequency of a video type application is at least 30 Hz. To ensure that images of all application programs can be displayed on a screen in a timely manner, a conventional LCD controller uses a relatively high refresh frequency, such as 60 Hz.

According to the foregoing solution, to ensure that an image is displayed on a screen in a timely manner, a relatively high refresh frequency is set, which causes excessive unnecessary refresh operations and corresponding operations of accessing a frame memory buffer, wastes system resources, and causes relatively high memory consumption.

### SUMMARY

Embodiments of the present invention provide a refresh control method and apparatus of a display device, which are used to avoid an unnecessary refresh operation, and reduce system resource consumption and memory consumption.

A first aspect of the embodiments of the present invention provides a refresh control method of a display device, where the display device includes a display controller and a display panel, and the method includes:

periodically generating, by the display controller, a first refresh signal, and outputting an image frame for display that is stored in a frame buffer to the display panel, where a period for generating the first refresh signal is shorter than duration in which a pixel of the display panel is distorted due to electric leakage; and

generating, by the display controller, a second refresh signal when determining that the image frame for display that is stored in the frame buffer changes; and outputting the image frame for display that is stored in the frame buffer to the display panel.

With reference to an implementation manner of the first aspect, in a first possible implementation manner, the generating, by the display controller, a second refresh signal when determining that the image frame for display that is stored in the frame buffer changes includes: generating, by the display controller, the second refresh signal when detecting that the image frame in the frame buffer is switched; and

the outputting the image frame for display that is stored in the frame buffer to the display panel includes: outputting the entire image frame for display that is stored in the frame buffer to the display panel.

With reference to the implementation manner of the first aspect, in a second possible implementation manner, the generating, by the display controller, a second refresh signal when determining that the image frame for display that is stored in the frame buffer changes includes:

when detecting that the image frame in the frame buffer is switched, obtaining, by the display controller, an image frame status parameter, and generating the second refresh signal according to the image frame status parameter, where the image frame status parameter identifies an address corresponding to changed image data in the image frame for display; and

the outputting the image frame for display that is stored in the frame buffer to the display panel includes:

outputting, to the display panel according to the second refresh signal, the image data that is corresponding to the address and is in the image frame for display that is stored in the frame buffer.

With reference to the second possible implementation manner of the first aspect, in a third possible implementation manner, that the image frame status parameter identifies an address corresponding to changed image data in the image frame for display includes:

the image frame status parameter is used to identify an address of a line, a column, or a pixel that is corresponding to the changed image data in the image frame for display; and

the outputting, to the display panel according to the second refresh signal, the image data that is corresponding to the address and is in the image frame for display that is stored in the frame buffer includes:

outputting, to the display panel according to the second refresh signal, image data corresponding to an address of a changed line, column, or pixel in the image frame for display that is stored in the frame buffer.

With reference to the third possible implementation manner of the first aspect, in a fourth possible implementation manner, the outputting, to the display panel, image data corresponding to an address of a changed line, column, or pixel in the image frame for display that is stored in the frame buffer includes:

sending a data reading request to a memory controller, where the data reading request is used to request to read the image data that is corresponding to the address of the line, the column, or the pixel and is in the image frame for display; and

receiving the image data returned by the memory controller, and outputting the received image data to the display panel.

A second aspect of the embodiments of the present invention provides a control apparatus of a display refresh, including:

a refresh controller, configured to: periodically generate a first refresh signal, and send the first refresh signal to a direct memory access controller, where a period for generating the first refresh signal is shorter than duration in which a pixel of a display panel is distorted due to electric leakage; and generate a second refresh signal when determining that an image frame for display that is stored in a frame buffer changes, and send the second refresh signal to the direct memory access controller; and

the direct memory access controller, configured to: after receiving the first refresh signal sent by the refresh controller, output the image frame for display that is stored in the frame buffer to the display panel; and after receiving the second refresh signal sent by the refresh controller, output the image frame for display that is stored in the frame buffer to the display panel.

With reference to an implementation manner of the second aspect, in a second possible implementation manner, the refresh controller is configured to: generate the second refresh signal when detecting that the image frame for display is switched, and send the second refresh signal to the direct memory access controller; and

the direct memory access controller is configured to: after receiving the second refresh signal, output the entire image frame for display that is stored in the frame buffer to the display panel.

With reference to the implementation manner of the second aspect, in a second possible implementation manner, the refresh controller is configured to: when detecting that the image frame for display is switched, obtain an image frame status parameter, generate the second refresh signal according to the image frame status parameter, and send the second refresh signal to the direct memory access controller, where the image frame status parameter identifies an address corresponding to changed image data in the image frame for display; and

the direct memory access controller is configured to: after receiving the second refresh signal, output, to the display panel according to the second refresh signal, image data that is corresponding to a changed address and is in the image frame for display that is stored in the frame buffer.

With reference to the second possible implementation of the second aspect, in a third possible implementation manner, the refresh controller is configured to obtain the image frame status parameter, where the image frame status parameter is used to identify an address of a line, a column, or a pixel that is corresponding to the changed image data in the image frame for display; and

the direct memory access controller is configured to: after receiving the second refresh signal, output, to the display panel according to the second refresh signal, image data that is corresponding to the address of the line, the column, or the pixel and is in the image frame for display that is stored in the frame buffer.

With reference to the third possible implementation manner of the second aspect, in a fourth possible implementation manner, the direct memory access controller is configured to: determine, according to the image frame status parameter included in the second refresh signal, an address of a changed line, column, or pixel in the image frame for display that is stored in the frame buffer; send a data reading request to the memory controller, where the data reading request is used to request to read the image data corresponding to the address of the changed line, column, or pixel in the image frame for display; receive the image data returned by the memory controller; and output the received image data to the display panel.

It may be seen from the foregoing technical solutions that, the embodiments of the present invention have the following advantages: A first refresh signal is periodically generated, which may prevent a pixel of a display panel from being distorted due to electric leakage. A generation frequency of a second refresh signal is set to prevent the pixel of the display panel from being distorted due to electric leakage, and therefore, the generation frequency is far less than a frequency required to ensure timely display of an image frame. In addition, when an image frame stored in a frame buffer changes, it may be determined that the image frame needs to be refreshed to the display panel. An operation of refreshing an image frame is triggered by monitoring an event of a change of the image frame, which may ensure that the image frame is displayed in a timely manner, and an excessively high refresh frequency is no longer required to ensure timely display of the image frame. Therefore, in the embodiments of the present invention, an unnecessary refresh operation may be avoided, so as to reduce system resource consumption and memory consumption.

### BRIEF DESCRIPTION OF DRAWINGS

To describe the technical solutions in the embodiments of the present invention more clearly, the following briefly introduces the accompanying drawings required for describing the embodiments.

FIG. 1 is a schematic structural diagram of a system of an application environment according to an embodiment of the present invention;

FIG. 2 is a schematic flowchart of a method according to an embodiment of the present invention;

FIG. 3 is a schematic structural diagram of a system according to an embodiment of the present invention;

FIG. 4 is a schematic structural diagram of a system according to an embodiment of the present invention;

FIG. 5 is a schematic structural diagram of a system according to an embodiment of the present invention;

FIG. 6 is a schematic flowchart of a method according to an embodiment of the present invention;

FIG. 7 is a schematic flowchart of a method according to an embodiment of the present invention;

FIG. 8 is a schematic flowchart of a method according to an embodiment of the present invention;

FIG. 9 is a schematic structural diagram of refresh logic of a line-based driven logic according to an embodiment of the present invention; and

FIG. 10 is a schematic structural diagram of an apparatus according to an embodiment of the present invention.

### DESCRIPTION OF EMBODIMENTS

To make the objectives, technical solutions, and advantages of the present invention clearer, the following further describes the present invention in detail with reference to the accompanying drawings.

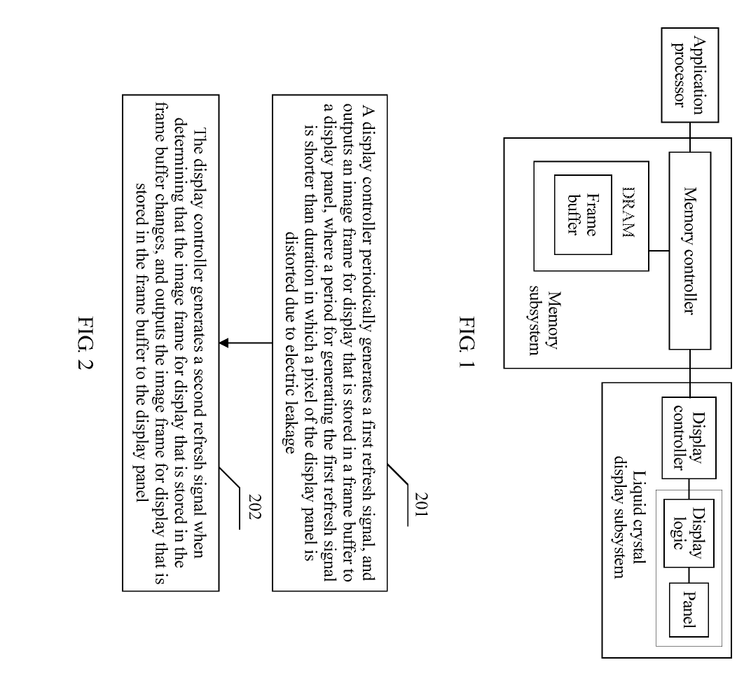

As shown in FIG. 1, FIG. 1 is an example of an application environment in an embodiment of the present invention. FIG. 1 shows a structural block diagram of a display system, and the display system mainly includes: an application processor (Application processors), a memory subsystem (memory subsystem), and a liquid crystal display subsystem (LCD display subsystem).

The application processor is responsible for writing image frame data into a frame buffer in a memory chip. In FIG. 1, the memory chip is a DRAM (Dynamic Random Access Memory, dynamic random access memory).

The memory subsystem includes two parts: a memory controller (memory controller) and a memory chip. The frame buffer is a partial area of the memory chip, and is only used to store image frame data. A display device may generally include multiple frame buffers. One frame buffer is used to store image frame data that needs to be currently displayed, and another frame buffer is used to prepare image frame data in background.

The liquid crystal display subsystem mainly includes two parts: a display controller and a display panel. The display panel includes display logic (Display logic) and a panel (display panel).

An embodiment of the present invention provides a refresh control method of a display device. As shown in FIG. 2, the method includes the following steps:

201. A display controller periodically generates a first refresh signal, and outputs an image frame for display that is stored in a frame buffer to a display panel, where a period for generating the first refresh signal is shorter than duration in which a pixel of the display panel is distorted due to electric leakage.

Because an event trigger manner is used to perform refresh in this embodiment of the present invention, a refresh frequency is extremely low in some scenarios. If the refresh frequency is too low, the pixel of the display panel of a display may be distorted due to electric leakage, and in this case, image distortion occurs. To avoid such a case, this step is used to ensure a lowest refresh frequency to prevent the pixel of the display panel from being distorted due to electric leakage. The duration in which the pixel of the display panel is distorted due to electric leakage refers to of a time period during which the pixel of the display panel is distorted due to electric leakage after charging ends.

In addition, in this embodiment of the present invention, in addition to the foregoing solution in which the first refresh signal is periodically generated, a solution to ensuring the lowest refresh frequency may further be, for example: monitoring refresh waiting duration (that is, waiting duration in which no image frame is output to the display panel), generating the first refresh signal if a difference between the refresh waiting duration and the duration of distortion caused by electric leakage of the display panel is less than a specified threshold, and outputting the image frame for display that is stored in the frame buffer to the display panel. In this solution, refresh does not need to be periodically performed, which may further avoid an unnecessary refresh operation.

The foregoing step 201 and a subsequent step 202 are synchronously executed with no particular order.

202. The display controller generates a second refresh signal when determining that the image frame for display that is stored in the frame buffer changes, and outputs the image frame for display that is stored in the frame buffer to the display panel.

In this embodiment of the present invention, an image frame is stored in a frame buffer, and there may be multiple frame buffers. In this embodiment of the present invention, a frame buffer used to store an image frame that needs to be displayed on the display panel needs to be monitored. A manner of determining whether the image frame for display that is stored in the frame buffer changes may be as follows: A memory controller performs monitoring, and transfers information obtained by means of monitoring to the display controller. That the memory controller monitors whether the image frame for display changes may be generally: monitoring whether data in the frame buffer changes. A monitoring manner varies according to a specific structure of a memory subsystem, and as long as a change of the image frame can be determined in a timely manner, this embodiment of the present invention sets no unique limitation thereto.

In this embodiment of the present invention, a first refresh signal is periodically generated, which may prevent a pixel of a display panel from being distorted due to electric leakage. A generation frequency of the second refresh signal is set to prevent the pixel of the display panel from being distorted due to electric leakage, and therefore, the generation frequency is far less than a frequency required to ensure timely display of an image frame. In addition, when an image frame stored in a frame buffer changes, it may be determined that the image frame needs to be refreshed to the display panel. An operation of refreshing an image frame is triggered by monitoring an event of a change of the image frame, which may ensure that the image frame is displayed in a timely manner, and an excessively high refresh frequency is no longer required to ensure timely display of the image frame. Therefore, in this embodiment of the present invention, an unnecessary refresh operation may be avoided, so as to reduce system resource consumption and memory consumption.

In this embodiment of the present invention, the event trigger manner may be refreshing the entire image frame for display (that is, global refresh), or may be refreshing a changed part in the image frame for display (that is, partial refresh). In addition, this embodiment of the present invention further provides a specific implementation solution to determine that the image frame changes, and a manner of the global refresh may be as follows:

The generating, by the display controller, a second refresh signal when determining that the image frame for display that is stored in the frame buffer changes includes: generating, by the display controller, the second refresh signal when detecting that the image frame in the frame buffer is switched.

The outputting the image frame for display that is stored in the frame buffer to the display panel includes: outputting the entire image frame for display that is stored in the frame buffer to the display panel.

This embodiment of the present invention further provides an optional implementation solution to determine whether the image frame for display that is stored in the frame buffer changes, and a solution of performing the partial refresh according to the optional implementation solution may be specifically as follows: The generating, by the display controller, a second refresh signal when determining that the image frame for display that is stored in the frame buffer changes includes:

when detecting that the image frame in the frame buffer is switched, obtaining, by the display controller, an image frame status parameter, and generating the second refresh signal according to the image frame status parameter, where the image frame status parameter identifies an address corresponding to changed image data in the image frame for display.

The outputting the image frame for display that is stored in the frame buffer to the display panel includes: outputting, to the display panel according to the second refresh signal, image data that is corresponding to a changed address and is in the image frame for display that is stored in the frame buffer.

In this embodiment, the image frame status parameter may be stored in a frame buffer status module, and the image frame status parameter is stored in the frame buffer status module by the memory controller after the memory controller determines, by means of monitoring, that the image frame for display that is stored in the frame buffer changes. The frame buffer status module may be a newly-added module in the memory subsystem. The display controller reads the image frame status parameter from the frame buffer status module.

Because the event trigger manner is used to perform refresh in this embodiment of the present invention, granularity division may be performed on an event of image frame updating. Therefore, only image frame data of a changed pixel, line, or column in an image frame is refreshed, and not all image frame data needs to be refreshed, thereby further reducing an amount of refreshed data, and reducing memory occupation. Specifically, that the image frame status parameter identifies a changed address in the image frame for display includes: The image frame status parameter is used to identify an address of a changed line, column, or pixel in the image frame for display.

The outputting, according to the second refresh signal, the image frame for display that is stored in the frame buffer to the display panel includes: outputting, to the display panel, image data corresponding to the address of the changed line, column, or pixel in the image frame for display that is stored in the frame buffer.

In this embodiment of the present invention, only a changed part in the image frame for display that is stored in the frame buffer may be refreshed, and therefore, in this embodiment of the present invention, data of a changed part in the image frame for display that is stored in the frame buffer needs to be obtained. This embodiment further provides a specific implementation manner of obtaining the data, which is as follows: The outputting, to the display panel, image data corresponding to the address of the changed line, column, or pixel in the image frame for display that is stored in frame buffer includes: determining, according to the image frame status parameter, the address of the changed line, column, or pixel in the image frame for display that is stored in the frame buffer;

sending a data reading request to the memory controller, where the data reading request is used to request to read the image data corresponding to the address of the changed line, column, or pixel is in the image frame for display; and

receiving the image data returned by the memory controller, and outputting the received image data to the display panel.

In the following embodiment, a specific implementation procedure of this embodiment of the present invention is described by using an example with reference to a possible schematic structural diagram of a display system.

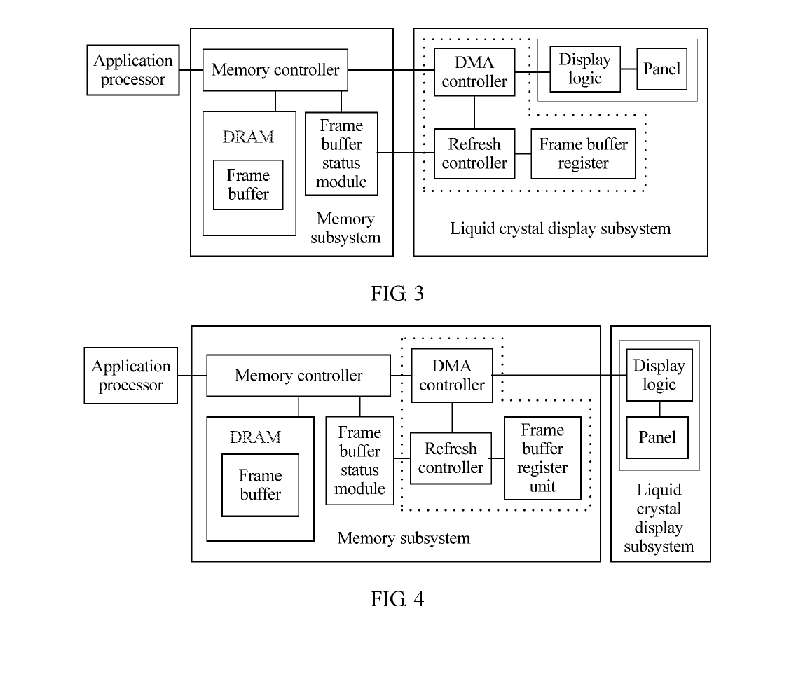

In a structural block diagram of a display system shown in FIG. 3, the display system mainly includes: an application processor (Application processors), a memory subsystem (memory subsystem), and a liquid crystal display subsystem (LCD display subsystem).

The application processor is responsible for writing image frame data into a frame buffer in a memory chip. In FIG. 3, the memory chip is a DRAM (Dynamic Random Access Memory, dynamic random access memory).

The memory subsystem includes three parts: a memory controller (memory controller), a memory chip, and a frame buffer status (Frame Buffer Status) module. The frame buffer is a partial area of the memory chip, and is only used to store image frame data. A display device may generally include multiple frame buffers. One frame buffer is used to store image frame data that needs to be currently displayed, and another frame buffer is used to prepare image frame data in background. The frame buffer status module is a newly-added module in this embodiment of the present invention, and is mainly used to store status information related to the frame buffer.

The liquid crystal display subsystem mainly includes two parts: a display controller (a part inside a dotted line frame) and a display panel. The display panel includes display logic (Display logic) and a panel (display panel). The display controller may be subdivided into three parts: a refresh controller (Refresh Controller), a DMA controller (DMA Controller), and a frame buffer register (Frame Buffer Regs).

In this embodiment of the present invention, the refresh controller may be implemented by a time driven logic circuit, and a frame refresh signal (a first refresh signal) is regularly triggered. In addition, a frame refresh signal (a second refresh signal) may further be driven by an event. Time driven refresh logic regularly generates a refresh signal according to a specified refresh frequency by using time sequence logic. For a display device such as an LCD that stores pixel data by using a capacitor, electric leakage of the capacitor causes pixel distortion. In this embodiment of the present invention, the time driven refresh logic may use a relatively low frequency to perform refresh, and regularly charges a capacitor of a pixel, as long as that the pixel is not distorted can be ensured. Event driven refresh logic may generate a frame refresh signal according to information related to the frame buffer, which mainly aims to display changed image frame in a timely manner.

A function of the DMA controller is to generate a series of DMA access requests according to an address of the frame buffer, and read image frame data in the frame buffer. The frame buffer register mainly records, in the display device that has multiple frame buffers, address information of a frame buffer that includes image frame data for currently displaying, which is similar to a function of the refresh controller. In the display device that has multiple frame buffers, when a new image frame is prepared, an operating system generates a frame switching operation, and sets a value of the frame buffer register as an address of a frame buffer that includes latest image frame data. That is, modification of the value of the frame buffer register represents switching in a frame buffer, and also means that drawing of a new image frame is completed and that the new image frame needs to be displayed on a screen in a timely manner. In this embodiment of the present invention, additional control logic may be added to transfer, to the refresh controller, information indicating that the value of the frame buffer register is modified.

In addition, frame buffer information collected by the memory controller needs to be transferred to the display controller, to control a pixel that needs to be refreshed. Therefore, in this embodiment of the present invention, an interaction channel is established between the memory controller and the display controller. The added frame buffer status module in the structural block diagram of the display system in this embodiment of the present invention and monitoring logic of the frame buffer register may simultaneously exist, or may separately exist.

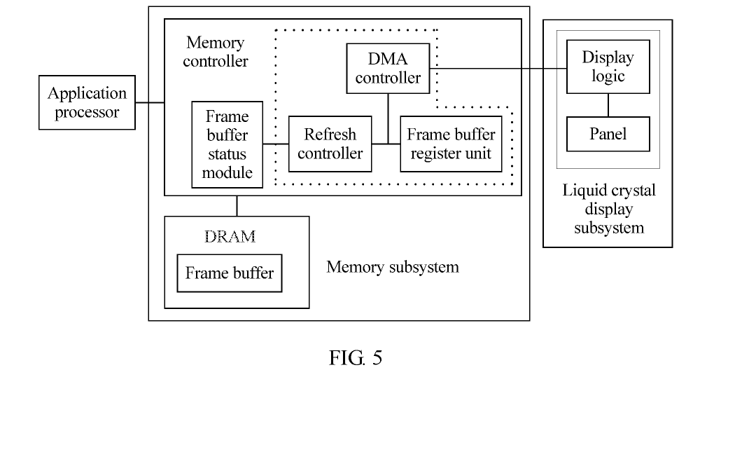

In addition, as shown in FIG. 4, the frame buffer status module, the refresh controller, the DMA controller, and the frame buffer register may simultaneously exist in the memory subsystem (or separately exist in the memory subsystem and the liquid crystal subsystem in FIG. 3). In addition, for example, as shown in FIG. 5, both the memory controller and the display controller are integrated in a same chip, and it may also be implemented that components such as the refresh controller and the DMA controller of the display system are integrated into the memory controller.

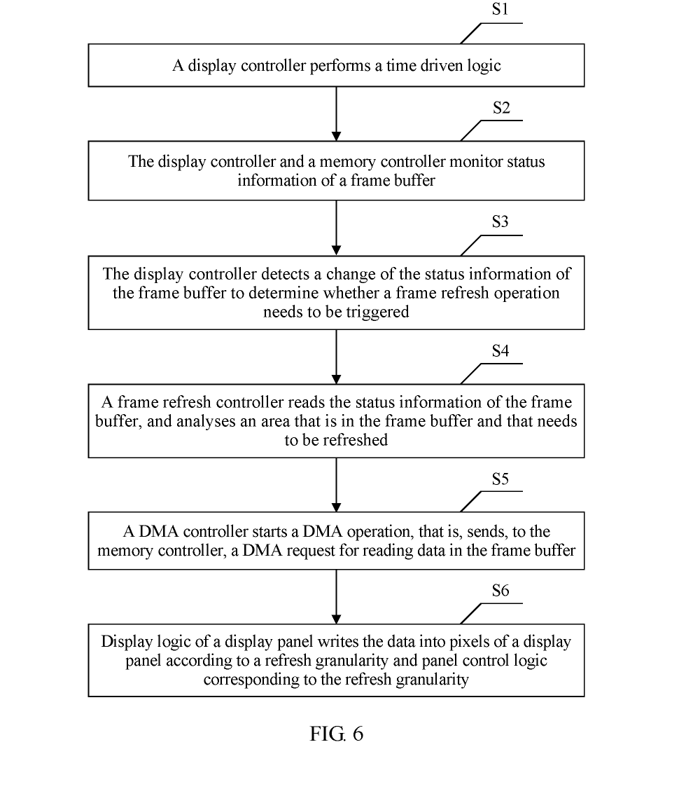

The following describes in detail a specific implementation procedure of this embodiment of the present invention, and the procedure is specifically shown in FIG. 6:

S1. A display controller performs time driven logic, and regularly triggers a frame refresh operation (a first refresh signal) according to relatively short refresh period.

In this step, a relatively low refresh frequency is relative to a fairly high refresh frequency that is set to ensure timely update. In a display with a capacitive screen, the relatively low refresh frequency herein only needs to ensure that a pixel is not distorted due to electric leakage of a capacitor of the display. Therefore, the refresh frequency herein is related to an electric leakage speed of the capacitor and a leaked electricity quantity corresponding to pixel distortion. A person skilled in the art may calculate, according to correspondences among a refresh frequency, an electric leakage speed, and a leaked electricity quantity, refresh frequencies corresponding to different displays. A specific value of the refresh frequency is not limited in this embodiment of the present invention. In addition, a person skilled in the art knows that, in this embodiment of the present invention, a periodical refresh frequency is more close to a lowest frequency required to prevent pixel distortion caused by electric leakage of the capacitor of the display, and more unnecessary refresh can be avoided.

S2. The display controller and a memory controller monitor status information of a frame buffer.

Status information that is of the frame buffers and is monitored by the display controller mainly refers to a switching operation (that is, whether an image frame in the frame buffer changes) in the frame buffer, and the switching operation in the frame buffer may be determined by using a change of a value of a frame buffer register.

Status information that is of the frame buffer and is monitored by the memory controller mainly refers to a modification status of image frame data. A frame buffer status module is configured to store status information indicating whether image frame data is modified, and the module generally includes an SRAM (Static Random Access Memory, static random access memory). The modification status of image frame data may be corresponding to a granularity of multiple types, for example, an entire frame buffer, a line, and a pixel. A finer granularity results in larger storage overheads.

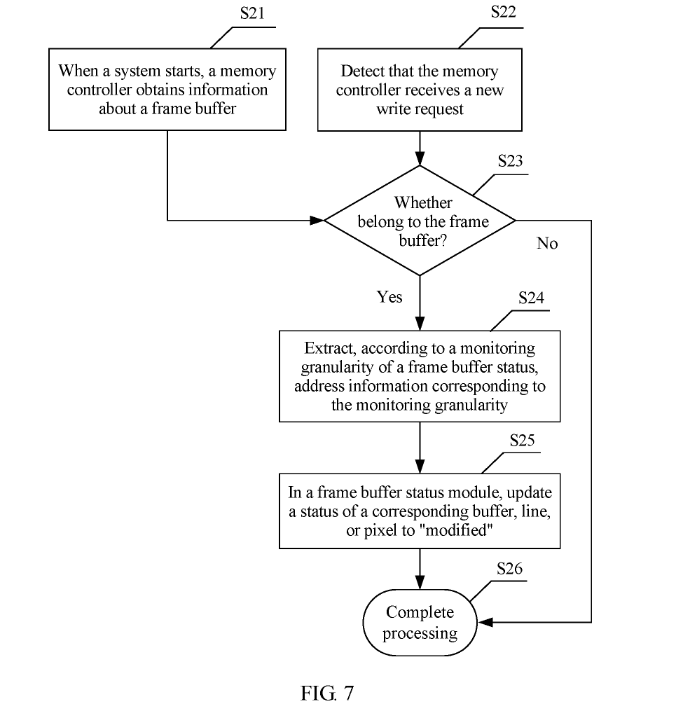

A function of monitoring the modification status of image frame data may be implemented by the memory controller by monitoring a write queue of the memory controller. The write queue of the memory controller includes all write requests for memory data. All modification to frame data is implemented by using a write request. In this embodiment of the present invention, a specific flowchart of obtaining a modification status of frame data is shown in the following FIG. 7:

S21. When a system starts, the memory controller obtains information about a frame buffer. The information that is about the frame buffer and is obtained by the memory controller may include a memory area corresponding to the information, a size of a frame buffer, a line quantity and a column quantity of each frame, a quantity of bytes occupied by each pixel, and the like.

S22. Start the following steps after it is detected that the memory controller receives a new write request and adds the new write request to a write request queue.

S23. Determine, according to the information that is about the frame buffer and is obtained by the memory controller in step S21, whether an address that the request requests to modify belongs to the frame buffer; if the address belongs to the frame buffer, execute step S24; if the address does not belong to the frame buffer, skip to step S26.

S24. Extract, according to a monitoring granularity of a frame buffer status, address information corresponding to the monitoring granularity, such as an entire frame buffer, a frame data line, or each pixel.

S25. In a frame buffer status module, update a status of a corresponding buffer, line, or pixel to “modified”. Generally, the status may be identified by using a bitmap, “0” indicates that data is unmodified, and “1” indicates that data is “modified”. The frame buffer status module may send a modified address and a corresponding value to a frame buffer register, so as to modify a value of the frame buffer register.

S26. Complete processing.

S3. The display controller detects a change of the status information of the frame buffer to determine whether a frame refresh operation needs to be triggered.

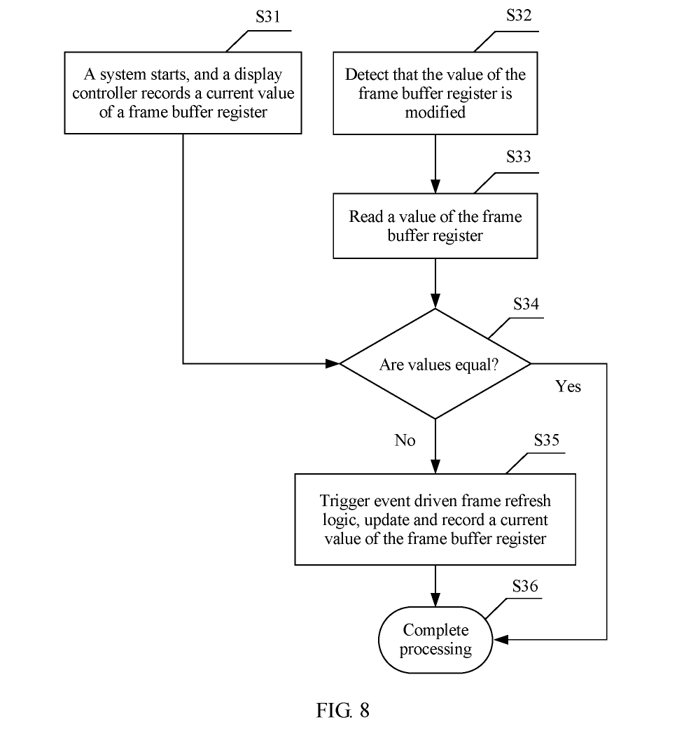

For a specific procedure for determining whether a frame refresh operation needs to be triggered, refer to FIG. 8. The specific procedure is as follows:

S31. The system starts, and the display controller records a current value of a frame buffer register.

S32. When the display controller detects that the value of the frame buffer register is modified, execute the following steps.

S33. Read a value of the frame buffer register.

S34. Determine whether the recorded value of the frame buffer register is equal to a new value written into the register; if the recorded value of the frame buffer register is equal to the new value written into the register, skip to step S36; if the recorded value of the frame buffer register is not equal to the new value written into the register, execute step S35.

S35. Instruct a refresh controller to trigger event driven frame refresh logic, to generate a frame refresh signal (a second refresh signal); in addition, update and record a current value of the frame buffer register for a next comparison.

S36. Complete processing.

S4. A frame refresh controller reads the status information of the frame buffer, and analyzes an area that needs to be refreshed in the frame buffer.

The status information in this step mainly refers to information recorded by the frame buffer status module in the memory controller, that is, a status identifying whether data is modified. If frame data is modified, the data needs to be read and displayed on a display panel; or if frame data is not modified, the data does not need to be read. The information recorded by the frame buffer status module may be refreshed at a monitoring granularity of an entire frame buffer, a frame cache line, or a pixel. Therefore, areas of the frame buffer that need to be refreshed are different in a case of different monitoring granularities.

S5. A DMA controller starts a DMA operation, that is, sends, to the memory controller, a DMA request for reading data in the frame buffer, and obtains changed image frame data in the frame buffer.

In this step, the DMA controller generates, according to information about modified data obtained in step S4, the DMA request to read the data.

S6. Display logic of a display panel writes the data into pixels of the display panel according to a refresh granularity (which is corresponding to a monitoring granularity) and panel control logic corresponding to the refresh granularity.

After step S6 is executed, go back to step S3, and repeatedly execute step S3.

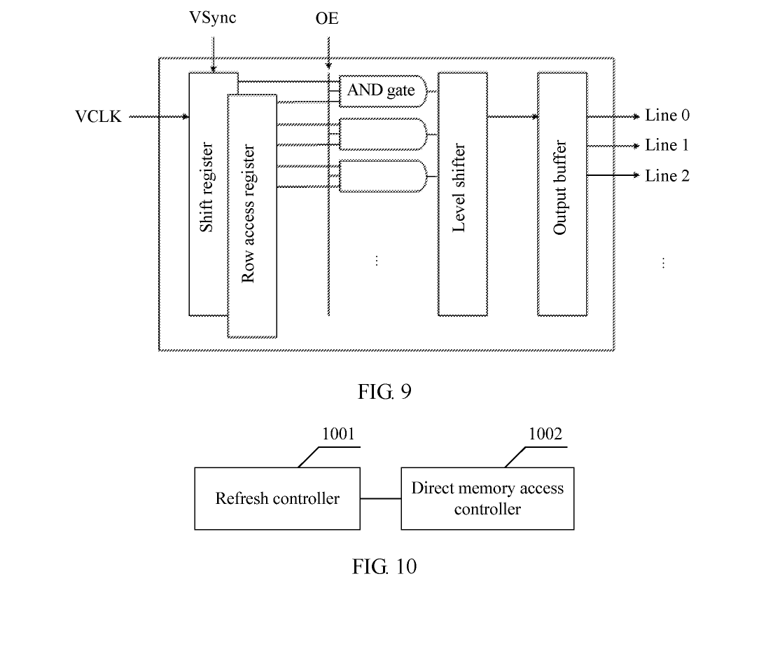

In step S6, the display logic of the display panel outputs only a changed part in an image frame to the panel for display. This embodiment of the present invention further provides a specific structure of the display logic. An example in which a monitoring granularity and a refresh granularity are a line is used for description, as shown in FIG. 9:

The display panel is refreshed generally in a progressive scanning manner from top to bottom and from left to right. Therefore, the refresh logic of the display panel may include line-based driven logic and column-based driven logic. In a process of performing event driven refresh in this embodiment of the present invention, not all pixels on the panel need to be refreshed, but only modified image frame data indicated in step S4 is refreshed. In this embodiment of the present invention, the refresh granularity may be a line or a pixel, and is the same as a monitoring granularity of the frame buffer status module. The control logic of the display panel adjusts the refresh logic according to the refresh granularity.

A structure in FIG. 9 is a schematic structural diagram of refresh logic of line-based driven logic that uses a cache line as a refresh granularity.

A shift register (Shift Registers) is configured to store an entire image frame, and control a line that currently needs to be refreshed, and the line is generally generated sequentially in a shift manner.

A level shifter (Level Shifters) and an output buffer (Output Buffer) are configured to generate a signal used to drive a current line (Line), and output, to a corresponding area (Line 0, Line 1, Line 2, or another line) of a panel, a line that needs to be refreshed.

The foregoing is a progressive refresh structure for an entire image frame. In comparison with progressive refresh logic for the entire image frame, a row access register (Row Access Registers), a corresponding signal cable, and an additional logic gate circuit are further added in this embodiment of the present invention.

The row access register is configured to store information indicating whether lines of an image frame for display that is in an entire frame buffer are modified, and this status may be information recorded in a frame buffer status module. When the row access register shows that a frame cache line is unmodified, a value corresponding to the row access register is 0.

An output enable (Output Enable, OE) signal allows enabling or disabling that a line outputs a signal. If that a line outputs signal is disabled, data cannot be written into all pixels of the line. Therefore, an objective of not refreshing data in a current line can be achieved by disabling that a line outputs a signal. VCLK is a clock signal source, and VSync is a signal source for enabling and driving progressive scanning.

When the row access register shows that a frame cache line is unmodified, a value corresponding to the row access register is 0. In this case, under functions of the OE signal and a gate circuit, data is not allowed to be written into all pixels corresponding to the line. On the contrary, when a frame cache line is modified, data is allowed to be written into a pixel corresponding to the line, and image frame data of the modified line needs to be written into the pixel. In this way, image frame data of a modified frame cache line is updated, and image frame data of an unmodified frame cache line remains unchanged. Therefore, an objective of partial refresh is achieved.

An embodiment of the present invention further provides a refresh control apparatus of a display device. As shown in FIG. 10, the apparatus includes:

a refresh controller 1001, configured to: periodically generate a first refresh signal, and send the first refresh signal to a direct memory access controller, where a period for generating the first refresh signal is shorter than duration in which a pixel of a display panel is distorted due to electric leakage; and generate a second refresh signal when determining that an image frame for display that is stored in a frame buffer changes, and send the second refresh signal to the direct memory access controller; and

the direct memory access controller 1002, configured to: after receiving the first refresh signal sent by the refresh controller 1001 or receiving the second refresh signal sent by the refresh controller 1001, output the image frame for display that is stored in the frame buffer of a memory to the display panel.

Because an event trigger manner is used to perform refresh in this embodiment of the present invention, a refresh frequency is extremely low in some scenarios. If the refresh frequency is too low, the pixel of the display panel of a display may be distorted due to electric leakage, and in this case, image distortion occurs. To avoid such a case, this step is used to ensure a lowest refresh frequency to prevent the pixel of the display panel from being distorted due to electric leakage.

In addition, in this embodiment of the present invention, in addition to the foregoing solution in which the first refresh signal is periodically generated, a solution to ensuring the lowest refresh frequency may further be, for example: monitoring refresh waiting duration (that is, waiting duration in which no image frame is output to the display panel), generating the first refresh signal if a difference between the refresh waiting duration and the duration of distortion caused by electric leakage of the display panel is less than a specified threshold, and outputting the image frame for display that is stored in the frame buffer to the display panel. In this solution, refresh does not need to be periodically performed, which may further avoid an unnecessary refresh operation.

In this embodiment of the present invention, an image frame is stored in a frame buffer, and there may be multiple frame buffers. In this embodiment of the present invention, a frame buffer used to store an image frame that needs to be displayed on the display panel needs to be monitored. A manner of determining whether the image frame for display that is stored in the frame buffer changes may be as follows: A memory controller performs monitoring, and transfers information obtained by means of monitoring to a refresh control apparatus of the display device. That the memory controller monitors whether the image frame for display changes may be generally: monitoring whether data in the frame buffer changes. A monitoring manner varies according to a specific structure of a memory subsystem, and as long as a change of the image frame can be determined in a timely manner, this embodiment of the present invention sets no unique limitation thereto.

In this embodiment of the present invention, a first refresh signal is periodically generated, which may prevent a pixel of a display panel from being distorted due to electric leakage. A generation frequency of the second refresh signal is set to prevent the pixel of the display panel from being distorted due to electric leakage, and therefore, the generation frequency is far less than a frequency required to ensure timely display of an image frame. In addition, when an image frame stored in a frame buffer changes, it may be determined that the image frame needs to be refreshed to the display panel. An operation of refreshing an image frame is triggered by monitoring an event of a change of the image frame, which may ensure that the image frame is displayed in a timely manner, and an excessively high refresh frequency is no longer required to ensure timely display of the image frame. Therefore, in this embodiment of the present invention, an unnecessary refresh operation may be avoided, so as to reduce system resource consumption and memory consumption.

In this embodiment of the present invention, the event trigger manner may be refreshing the entire image frame for display (that is, global refresh), or may be refreshing a changed part in the image frame for display (that is, partial refresh). In addition, this embodiment of the present invention further provides a specific implementation solution to determine that the image frame changes, and an implementation solution of the global refresh may be as follows:

The refresh controller 1001 is configured to: generate the second refresh signal when detecting that the image frame for display is switched, and send the second refresh signal to the direct memory access controller 1002.

The direct memory access controller 1002 is configured to: after receiving the second refresh signal, output the entire image frame for display that is stored in the frame buffer to the display panel.

This embodiment of the present invention further provides an optional implementation solution to determine whether the image frame for display that is stored in the frame buffer changes, and a solution of performing the partial refresh according to the optional implementation solution may be specifically as follows:

The refresh controller 1001 is configured to: when detecting that the image frame for display is switched, obtain an image frame status parameter, generate the second refresh signal, and send the second refresh signal to the direct memory access controller 1002, where the image frame status parameter identifies an address corresponding to changed image data in the image frame for display.

The direct memory access controller 1002 is configured to: after receiving the second refresh signal, output, to the display panel according to the second refresh signal, image data that is corresponding to a changed address and is in the image frame for display that is stored in the frame buffer.

In this embodiment, the image frame status parameter may be stored in a frame buffer status module, and the image frame status parameter is stored in the frame buffer status module by the memory controller after the memory controller determines, by means of monitoring, that the image frame for display that is stored in the frame buffer changes. The frame buffer status module may be a newly-added module in the memory subsystem. The display controller reads the image frame status parameter from the frame buffer status module.

Because the event trigger manner is used to perform refresh in this embodiment of the present invention, granularity division may be performed on an event of image frame updating. Therefore, only image frame data of a changed pixel, line, or column in an image frame is refreshed, and not all image frame data needs to be refreshed, thereby further reducing an amount of refreshed data, and reducing memory occupation.

Specifically, the refresh controller 1001 is configured to obtain the image frame status parameter, where the image frame status parameter is used to identify an address of a changed line, column or pixel in the image frame for display.

The direct memory access controller 1002 is configured to: after receiving the second refresh signal, output, to the display panel, image data corresponding to the address of the changed line, column, or pixel in the image frame for display that is stored in the frame buffer.

In this embodiment of the present invention, only a changed part in the image frame for display that is stored in the frame buffer may be refreshed, and therefore, in this embodiment of the present invention, data of a changed part in the image frame for display that is stored in the frame buffer needs to be obtained. This embodiment further provides a specific implementation manner of obtaining the data, which is as follows: The direct memory access controller 1002 is configured to: determine, according to the image frame status parameter, the address of the changed line, column, or pixel in the image frame for display that is stored in the frame buffer; send a data reading request to the memory controller, where the data reading request is used to request to read the image data corresponding to the address of the changed line, column, or pixel in the image frame for display; receive the image data returned by the memory controller; and output the received image data to the display panel.

It should be noted that, in the foregoing apparatus and system embodiments, the unit division is merely logical function division, but the present invention is not limited to the foregoing division, as long as corresponding functions can be implemented. In addition, specific names of the functional units are merely provided for the purpose of distinguishing the units from one another, but are not intended to limit the protection scope of the present invention.

In addition, a person of ordinary skill in the art may understand that all or a part of the steps of the method embodiments may be implemented by a program instructing relevant hardware. The program may be stored in a computer readable storage medium. The storage medium may include: a read-only memory, a magnetic disk, or an optical disc.

The foregoing descriptions are merely exemplary implementation manners of the present invention, but are not intended to limit the protection scope of the present invention. Any variation or replacement readily figured out by a person skilled in the art within the technical scope disclosed in the embodiments of the present invention shall fall within the protection scope of the present invention. Therefore, the protection scope of the present invention shall be subject to the protection scope of the claims.

What is claimed is:

1. A refresh control method of a display system, wherein the display system comprises a display controller, a display panel and a frame buffer for storing one image frame at each time, wherein the display controller comprises a refresh controller and a direct memory access (DMA) controller, the method comprises:
periodically generating, by the refresh controller, a first refresh signal;
sending, by the refresh controller, the first refresh signal to the DMA controller;
generating, by the refresh controller, a second refresh signal when determining that an image frame stored in the frame buffer changes;
sending, by the refresh controller, the second refresh signal to the DMA controller;
reading, by the DMA controller, an image frame currently stored in the frame buffer in response to each of the first refresh signal and the second refresh signal;
sending, by the DMA controller, the image frame currently stored in the frame buffer to the display panel.

2. The method according to claim 1, wherein a period for generating the first refresh signal is shorter than duration for pixels of the display panel to remain free from distortion due to electric leakage.

3. The method according to claim 1, wherein:
the generating, by the refresh controller, the second refresh signal when determining that the image frame stored in the frame buffer changes comprises:
obtaining, by the refresh controller, an image frame status parameter when determining that the image frame stored in the frame buffer changes, wherein the image frame status parameter identifies an address corresponding to changed image data in the image frame stored in the frame buffer;
generating, by the refresh controller, the second refresh signal according to the image frame status parameter; and
the reading, by the DMA controller, the image frame currently stored in the frame buffer in response to the second refresh signal and the sending, by the DMA controller, the image frame currently stored in the frame buffer to the display panel comprises:
reading, by the DMA controller, changed image data in the image frame currently stored in the frame buffer according to the second refresh signal;
sending, by the DMA controller, the changed image data in the image frame currently stored in the frame buffer to the display panel.

4. The method according to claim 3, wherein the image frame status parameter is used to identify an address of a line, a column, or a pixel that is corresponding to the changed image data in the image frame stored in the frame buffer.

5. A refresh control apparatus applied in a display system comprising a display panel and a frame buffer for storing one image frame at each time, and the refresh control apparatus comprise:
a refresh controller, configured to: periodically generate a first refresh signal; send the first refresh signal to a direct memory access (DMA) controller; generate a second refresh signal when determining that an image frame stored in the frame buffer changes; and send the second refresh signal to the DMA controller;
the DMA controller, configured to: read an image frame currently stored in the frame buffer in response to each of the first refresh signal and the second refresh signal; and send the image frame currently stored in the frame buffer to the display panel.

6. The apparatus according to claim 5, wherein a period for generating the first refresh signal is shorter than duration for pixels of the display panel to remain free from distortion due to electric leakage.

7. The apparatus according to claim 5, wherein:
the refresh controller, configured to: obtain an image frame status parameter when determining that the image frame stored in the frame buffer changes, wherein the image frame status parameter identifies an address corresponding to changed image data in the image frame stored in the frame buffer; and generate the second refresh signal according to the image frame status parameter;
the DMA controller, configured to: in response to the second refresh signal, read changed image data in the image frame currently stored in the frame buffer according to the second refresh signal; and send the changed image data in the image frame currently stored in the frame buffer to the display panel.

8. The apparatus according to claim 7, wherein the image frame status parameter is used to identify an address of a line, a column, or a pixel that is corresponding to the changed image data in the image frame stored in the frame buffer.
